(19) United States
(12) Patent Application Publication
(10) Pub. No.: US 2004/0078434 A1
(43) Pub. Date: Apr. 22, 2004

(54) Method, system and program product for automated document export control

(75) Inventors: Richard G. Parker, Fort Worth, TX (US); Graham Rutherford, Fort Worth, TX (US)

Correspondence Address: BRACEWELL & PATERSON, L.L.P., 711 LOUISIANA STREET, SUITE 2900, HOUSTON, TX, 77002-2781, US

(73) Assignee: Lockheed Martin Corporation

(21) Appl. No.: 10/273,214

(22) Filed: Oct. 17, 2002

(51) Int. Cl. G06F 15/16

(52) U.S. Cl. 709/206

(57) ABSTRACT

An automated method, system and program product for automated document export control are disclosed. In accordance with the present invention, a user, by entering one or more user inputs into a data processing system, builds and submits an electronic document export request specifying a document for which export authorization is requested, an identity of an export control reviewer, and an indication of an export control policy under which export of the document is permitted. In response to submission of the electronic document export request, the data processing system automatically notifies the export control reviewer of the electronic document export request and permits the export control reviewer to electronically access, review and annotate the electronic document export request. Then, in response to the export control reviewer annotating the electronic document export request as approved, the electronic document export request is electronically archived, and approval of the export request is electronically indicated to the user. In this manner, paper copies and physical handling of the document export request can be advantageously eliminated.

### BACKGROUND OF THE INVENTION

1. Technical Field

The present invention relates generally to document management and in particular to a method, apparatus and program product for automated document export control.

2. Description of the Related Art

Many companies, particularly those having significant technical or proprietary information, implement document management systems to manage the creation, storage, modification, and archiving of information contained within hardcopy and/or electronic documents. In a typical corporate environment, document management is handled electronically, and the document management system is a computer-based software package that provides a graphical user interface through which users can create, storage, modify and archive electronic documents subject to various access permissions (e.g., user authentication, distribution lists, read-only, proper security clearance, etc.).

Companies frequently operate under various internal policies, procedures and agreements, as well as governmental laws and regulations, governing the dissemination of company information outside of the company, outside of specified geographic or political boundaries, or to foreign nationals. For example, in order to safeguard national security and reduce international industrial espionage, the export of technical data out of the United States is restricted not only by company policies, procedures and agreements, but also by regulations (e.g., International Traffic in Arms Regulations (ITAR)) promulgated by the United States Department of State.

Although the documents subject to dissemination controls are usually created, viewed, edited, and stored in electronic form in a typical corporate environment, the policies and procedures utilized to regulate the dissemination of such documents are typically not automated. For example, in order to obtain approval to export or otherwise disseminate an electronic document containing technical information, an employee must often provide one or more reviewers with a hardcopy request packet, including, for example, the document (or a description of the document) for which export license or other approval is required, the license, exemption or policy under which permission to disseminate is sought, identification of the individual certifying the export, the intended recipient, the date and time of the planned dissemination, etc.

Once this hardcopy request packet has been compiled by the employee, the packet is often routed by inter-office mail or the like between multiple reviewers until final approval is obtained and documented. Upon approval or denial of the employee's request, hardcopy notification is provided to the employee requesting permission to disseminate the document, and the packet may be archived in a paper file for future reference.

### SUMMARY OF THE INVENTION

The present invention recognizes the above-described conventional process of obtaining authorization to export or otherwise disseminate information is time-consuming for the employee, requires a long lead time to obtain authorization, and consumes significant corporate resources to create, transmit, and archive hardcopies of the request packet. The present invention therefore provides an automated method, system and program product for automated document export control.

In accordance with the present invention, a user, by entering one or more user inputs into a data processing system, builds and submits an electronic document export request specifying a document for which export authorization is requested, an identity of an export control reviewer, and an indication of an export control policy under which export of the document is permitted. In response to submission of the electronic document export request, the data processing system automatically notifies the export control reviewer of the electronic document export request and permits the export control reviewer to electronically access, review and annotate the electronic document export request. Then, in response to the export control reviewer annotating the electronic document export request as approved, the electronic document export request is electronically archived, and approval of the export request is electronically indicated to the user. In this manner, paper copies and physical handling of the document export request can be advantageously eliminated.

Additional objects, features, and advantages of the present invention will become apparent from the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts an exemplary data network in which the present invention can advantageously be implemented;

FIG. 2 is a flowchart of an exemplary method of document export control in accordance with an illustrative embodiment of the present invention;

FIG. 3 depicts a browser window through which a user can enter attributes of an electronic document export request in accordance with an illustrative embodiment of the present invention; and

FIG. 4 illustrates a browser window through which an export control reviewer can access, review, annotate an electronic document export request in accordance with an illustrative embodiment of the present invention.

### DETAILED DESCRIPTION OF AN ILLUSTRATIVE EMBODIMENT

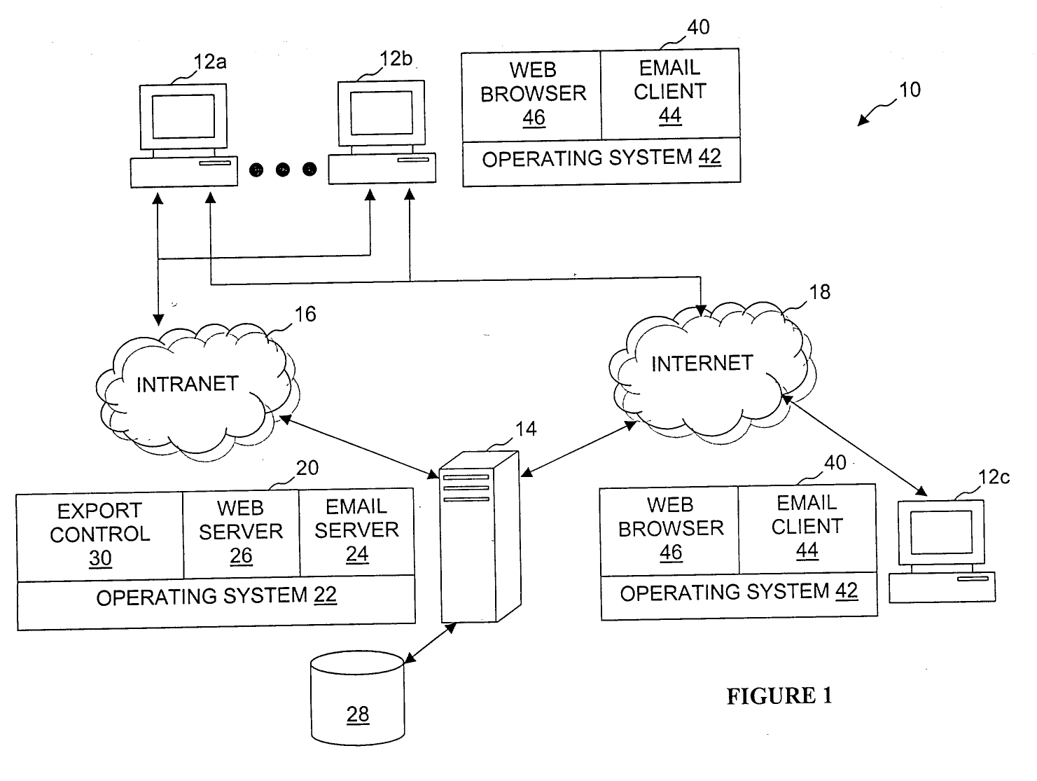

With reference now to the figures and in particular to FIG. 1, there is depicted an exemplary data network in which the present invention can advantageously be implemented. As shown, data network 10 includes a number of client computers 12a-12c, which may comprise, for example, desktop, workstation, laptop or handheld computer systems. Data network 10 further includes one or more server computers 14 (only one of which is shown), which is coupled for communication with clients 12a-12cby one or more local area and/or wide area networks such as intranet 16 and Internet 18. In the illustrated embodiment, client computers 12a and 12b belong to a same organization (e.g., corporation) and are accordingly connected to server computer 14 by intranet 16 and optionally Internet 18. Client computer 12c does not belong to the same organization and/or is not within the same geographical region (e.g., national boundaries) as server computer 14 and client computers 12a-12b and accordingly is not coupled to intranet 16, but is instead coupled to server computer 14 by Internet 18. As will be appreciated by those skilled in the art, communication on networks 16 and 18 can be conducted utilizing any of a number of well known protocols, including, inter alia, the Transport Control Protocol/Internet Protocol (TCP/IP) protocol suite and the Hypertext Transfer Protocol (HTTP) and Hypertext Transfer Protocol over Secure Socket Layer (HTTPS) commonly employed for communication over Internet 18.

FIG. 1 also illustrates exemplary software configurations 20 and 40 of server computer 14 and client computers 12, respectively. As indicated, software configuration 20 of server computer 14 includes an operating system 22, such as Windows NT® or UNIX®, which controls and provides basic functionality to server computer 14. Software configuration 20 further includes an electronic mail (email) server 24 that provides electronic mail communication between client computers 12a-12c and a web server 26 that serves web pages residing within data storage 28 to client computers 12a-12c. Software configuration 20 also includes export control software 30, which, as described in detail below, controls the electronic and/or physical dissemination of documents by users of client computers 12a-12b to recipients, such as the user of client computer 12c, who is a foreign national and/or outside of the organization and/or national boundaries to which client computers 12a-12b belong. As will be appreciated from the description below, export control software 30 may be implemented with a special purpose software package or may alternatively be implemented by customizing a commercially available workplace management tool, such as the Livelink® software package available from Open Text Corporation of Waterloo, Canada.

FIG. 1 further illustrates the software configuration 40 of client computers 12a-12c.

Although not necessarily identical, the software configuration 40 of each of client computers 12a-12c generally includes an operating system (e.g., one of the Windows® operating systems developed by Microsoft Corporation of Redmond, Wash.), as well as a conventional email client 44 and web browser 46.

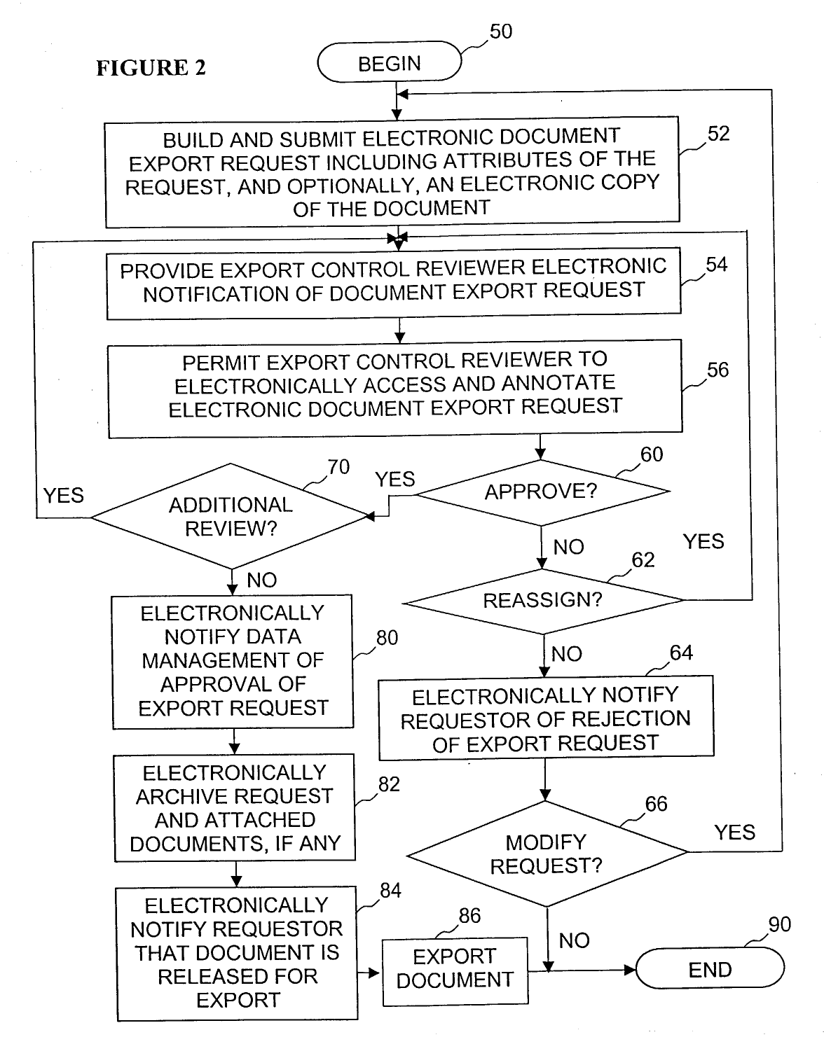

Referring now to FIG. 2, there is illustrated a high level logical flowchart of a method of controlling the dissemination of a document in accordance with an illustrative embodiment of the present invention. To promote understanding, the method depicted in FIG. 2 is described herein with reference to various hardware and software components of data network 10 of FIG. 1; however, it should be understood that the present invention is not limited to the particular hardware and software embodiments shown in FIG. 1, but can instead be realized utilizing a variety of hardware and software.

As shown, the method of FIG. 2 begins at block 50 and thereafter proceeds to block 52, which illustrates a user, for example, the user of client computer 12a, building and submitting an electronic document export request to export a document outside of the organization to which he belongs or to a foreign country or to a foreign national, for example, by sending the document to the user of client computer 12c. In the embodiment shown in FIG. 1, the user of client computer 12a composes the electronic document export request by utilizing web browser 46 (and web server 26 of server computer 14) to access export request composition functionality of export control software 30 on server computer 14.

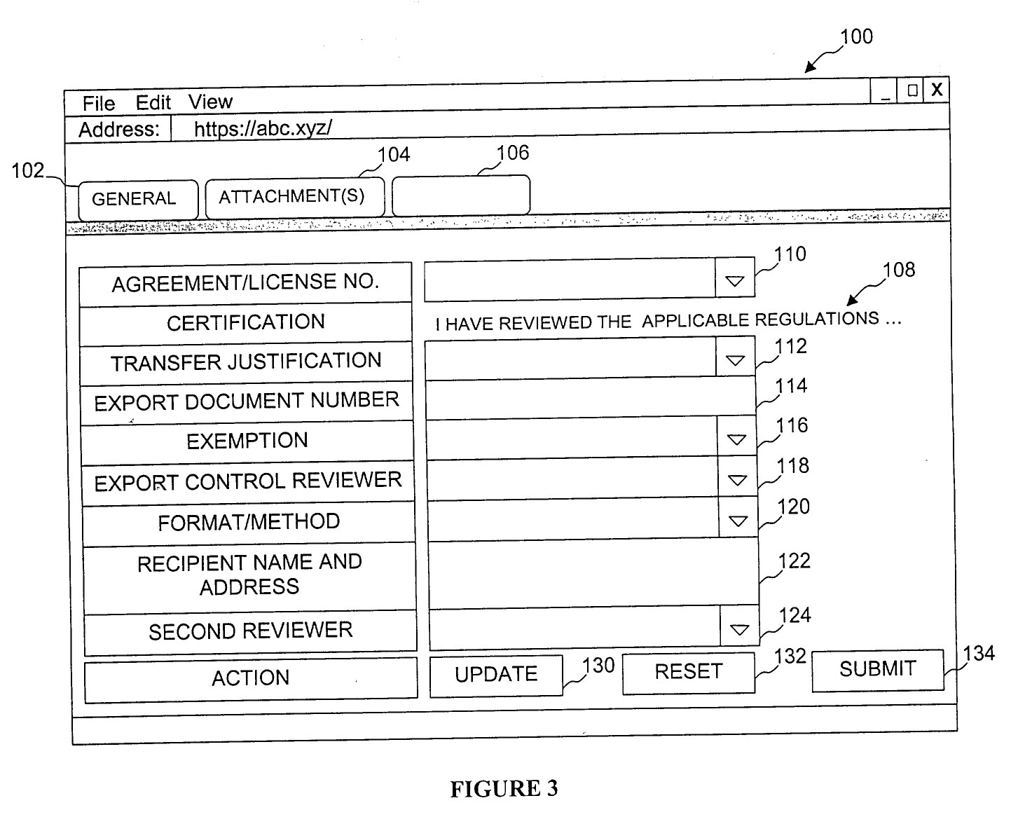

For example, after entering the Universal Resource Locator (URL) associated with export control software 30 in web browser 46 and successfully completing a password authentication presented by export control software 30, the user can build the electronic document export request by completing various fields presented by export control software 30 within a window of web browser 46. These fields may include the title of the document export request, as well as a number of attribute fields. The attribute fields preferably include the regulatory authority (e.g., export license or exemption, corporate regulation, technology transfer agreement, etc.) under which export is alleged to be authorized, identifying information for the intended recipient of the document to be exported, the identity of an export control reviewer that will review the request, and the format of the document to be exported (e.g., hardcopy, electronic document with electronic delivery, or electronic document embodied in physical medium). An exemplary embodiment of browser window permitting entry of these and other attributes is depicted in FIG. 3.

As shown in FIG. 3, browser window 100 includes a number of navigation tabs 102-106 to permit the user of client computer 12a to easily navigate (e.g., utilizing a mouse or other graphical pointing device) between various fields in which the user enters information to compose the electronic document export request. In the depicted scenario, the user has selected navigation tab 106 to permit the user to enter the attributes of the electronic document export request within a number of attribute fields. These attribute fields include an export document number field 114 in which the user identifies by document number the document to be exported, an agreement/license number field 110 and exemption field 116 in which the user identifies the agreement, license or exemption under which the requested export is permitted, a transfer justification field 112 in which the user enters a reason as to why export is required, an export control reviewer field 118 and second reviewer field 124 in which the user indicates the first (and possibly second) reviewer of the electronic document export request, a format/method field 120 in which the user indicates the format and delivery method of the document to be exported, and a recipient field 122 in which the user specifies the name and address of the recipient of the document. Browser window 100 also contains a certification statement 108 in which the user certifies that the requested export complies with applicable laws, regulations and policies, as well as update and reset buttons 130 and 132, which a user can select to save the information entered within fields 110-124 or reset all fields 110-124 to default settings.

If the document to be exported is in electronic format, the user can also select navigation tab 104, which will cause export control software 30 to present the user with an interface through which the user may attach an electronic version of the document to be exported to the electronic document export request. As will be appreciated, the electronic version of the document may reside on client computer 12a or on a remote document database, for example, within data storage 28.

After the user has completed entry of at least all required fields of the electronic document export request, the user electronically submits the request by selecting submit button 134. Submission of the electronic document export request initiates review of the electronic document export request by at least one export control reviewer indicated within the request.

Referring again to FIG. 2, following block 52 the process proceeds to block 54. Block 54 illustrates export control software 30 providing the export control reviewer specified within the electronic document export request with electronic notification of the electronic document export request, for example, via email server 24 and email client 44 of client computer 12b. In this embodiment, the email notification preferably contains a hyperlink to the electronic document export request residing on server, which, when selected by the reviewer, permits the user to access, view and annotate the electronic document export request created by the user of client computer 12a. As will be appreciated by those skilled in the art, email client 46 may advantageously be programmed to automatically alert the user of client computer 12b (e.g., via popup window and/or audio presentation) in response to receipt of the email notification.

As shown at block 56 of FIG. 2, after receiving the electronic notification from export control software 30, the export control reviewer can select the hyperlink embedded within the email notification so that, following login, the export control reviewer is permitted to access, review and annotate the electronic document export request maintained by export control software 30. Of course, the export control reviewer may alternatively access the electronic document export request directly from web browser 46 by entering the appropriate URL into a web browser window. Thus, the export reviewer is permitted to conveniently review the electronic document export request (and if attached in electronic form, the document itself) without requiring a hardcopy of the request and document to be produced and routed to the export control reviewer.

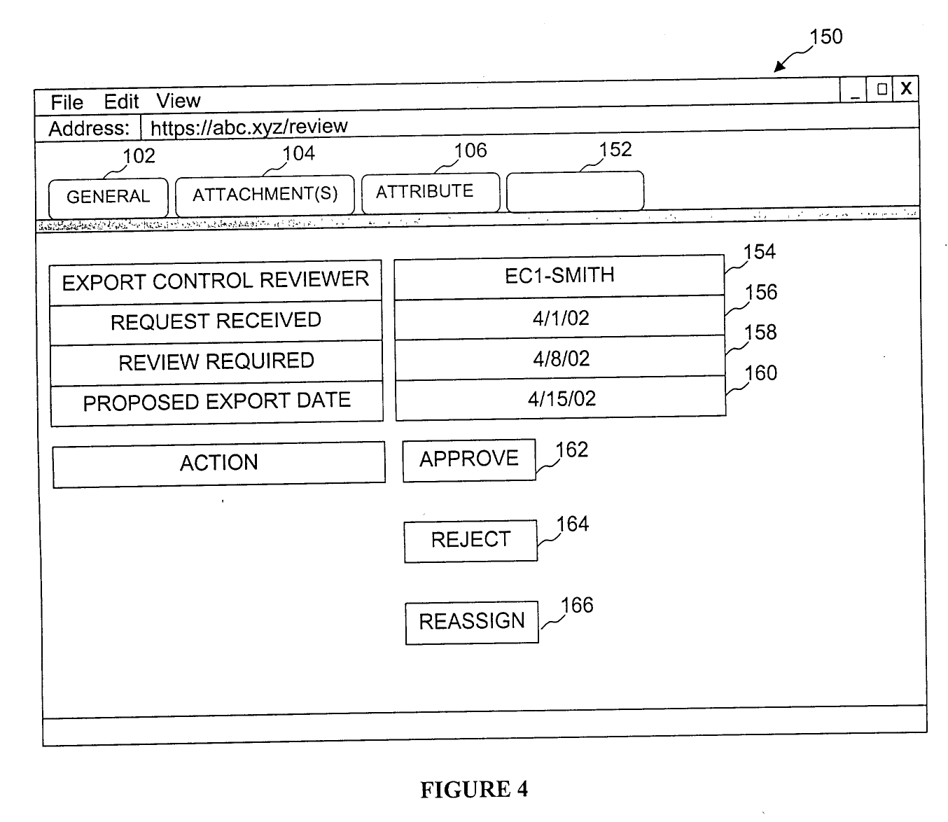

As shown in FIG. 4, in addition to viewing the request itself, the export control reviewer can select navigation tab 152 within browser window 150 in order to view the routing and timetable of the electronic document export request presented within fields 154-160. Within browser window 150 export control software 30 also displays buttons 162-166, which respectively permit the export control reviewer to electronically approve, reject, or (if permitted) reassign the request to another reviewer.

As depicted at blocks 60-62 of FIG. 2, export control software 30 initiates a next request processing step in response to selection of one of buttons 162-166 by the export control reviewer. If the export control reviewer selects approve button 162, the process illustrated in FIG. 2 passes to block 70, which is described below. If the export control reviewer selects reassign button 166, the process passes to block 54, which illustrates export control software 30 notifying a different export control reviewer of the electronic document export request and permitting the new export control reviewer to review the request, as discussed above. If, however, the export control reviewer selects reject button 164, export control software 30 electronically notifies (e.g., by email) the user of client computer 12a that originally submitted the electronic document export request of the rejection of the request. As indicated at block 66, the user is then permitted to modify the electronic document export request. If the user chooses to do so, the process returns to block 52, which has been described. If not, the electronic document export request remains rejected, and the process depicted in FIG. 2 terminates at block 90.

With reference again to block 70 of FIG. 2, if the first export control reviewer approves the electronic document export request and additional review is required, export control software 30 automatically notifies a second export control reviewer as indicated at block 54, and the second export control reviewer performs a second review of the electronic document export request as shown at block 56. Once the electronic document export request has been approved by all required reviewers, the process depicted in FIG. 2 proceeds to blocks 80-82, which illustrate export control software 30 electronically notifying data management of approval of the electronic document export request and data management electronically archiving the request and attached document(s), if any. The operations illustrated at blocks 80-82 can be implemented in a number of ways.

For example, if data management is entirely automated, blocks 80-82 can be performed simply by export control software 30 storing the electronic document export request and attached files, if any, within a document database, for example, within data storage 28. If, on the other hand, data management includes the involvement of human personnel (e.g., the user submitting the request, an export control reviewer, or a third party), the notification depicted at block 80 may be provided by email, and the archiving of the request illustrated at block 82 may include human-initiated electronic archival operations.

As indicated at block 84 of FIG. 2, after the request and any attached documents are archived, export control software 30 preferably provides email or other electronic notification to the user that made the electronic document export request that it has been approved. Of course, such notification can be selectively omitted if the user has already been notified at block 80. The user can then export the document to the user of client computer 12c, as illustrated at block 86. As will be appreciated, the document can be exported in any number of ways, including attaching the document to an email, providing an email containing a hyperlink to the document, or physical delivery of a hardcopy or electronic copy of the document. Following block 86, the process terminates at block 90.

As has been described, the present invention provides a method, system and program product for automated document export control. In accordance with the present invention, an electronic request to export a document is created, routed, and ultimately approved or rejected, all utilizing electronic means. In this manner, conventional production, routing, handling, and archiving of hardcopy request packages is advantageously eliminated.

While the invention has been particularly shown and described with reference to a preferred embodiment, it will be understood by those skilled in the art that various changes in form and detail may be made therein without departing from the spirit and scope of the invention. For example, although aspects of the present invention have been described with respect to a computer system executing software that directs the functions of the present invention, it should be understood that present invention may alternatively be implemented as a program product for use with a data processing system. Programs defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention.

1. A computer-based method of controlling dissemination of a document, said method comprising:
in response to one or more user inputs into a data processing system, building and submitting an electronic document export request specifying a document for which export authorization is requested, an identity of an export control reviewer, and an indication of an export control policy under which export of the document is permitted;
in response to submission of the electronic document export request, the data processing system automatically notifying the export control reviewer of the electronic document export request and permitting the export control reviewer to electronically access, review and annotate the electronic document export request; and
in response to the export control reviewer annotating the electronic document export request as approved, electronically archiving the electronic document export request and electronically indicating to a user that export of the document has been approved.

2. The method of claim 1, wherein building an electronic document export request comprises building an electronic document export request including an electronic copy of the document to be exported.

3. The method of claim 1, and further comprising automatically notifying the user that export of the document has been approved.

4. The method of claim 1, wherein building an electronic document export request comprises building an electronic document export request including a format attribute indicating a medium format of the document.

5. The method of claim 1, wherein building an electronic document export request comprises building an electronic document export request including a written certification by the user that export of the document complies with applicable export regulations.

6. The method of claim 1, and further comprising electronically exporting the document in response to approval of the electronic document export request.

7. The method of claim 1, wherein said export control reviewer is a first export control reviewer, said method further comprising:
in response to said first export control reviewer annotating the electronic document export request as approved for export, the data processing system automatically notifying a second export control reviewer of the electronic document export request and permitting the export control reviewer to electronically access, review and annotate the electronic document export request;
wherein said data processing system archives the electronic document export request and indicates to a user that export of the document has been approved only in response to both of said first and second export control reviewers annotating the electronic document export request with approval of export of the document.

8. The method of claim 1, and further comprising in response to the export control reviewer annotating the electronic document export request with rejection of the electronic document export request, electronically indicating said rejection to the user and permitting the user to modify the electronic document export request.

9. A data processing system, comprising:
means, responsive to one or more user inputs into a data processing system, for building and submitting an electronic document export request specifying a document for which export authorization is requested, an identity of an export control reviewer, and an indication of an export control policy under which export of the document is permitted;
means, responsive to submission of the electronic document export request, for automatically notifying the export control reviewer of the electronic document export request and permitting the export control reviewer to electronically access, review and annotate the electronic document export request; and
means, responsive to the export control reviewer annotating the electronic document export request as approved, for electronically archiving the electronic document export request and electronically indicating to a user that export of the document has been approved.

10. The data processing system of claim 9, wherein said means for building an electronic document export request comprises means for building an electronic document export request including an electronic copy of the document to be exported.

11. The data processing system of claim 9, and further comprising means for automatically notifying the user that export of the document has been approved.

12. The data processing system of claim 9, wherein said means for building an electronic document export request comprises means for building an electronic document export request including a format attribute indicating a medium format of the document.

13. The data processing system of claim 9, wherein the means for building an electronic document export request comprises means for building an electronic document export request including a written certification by the user that export of the document complies with applicable export regulations.

14. The data processing system of claim 9, and further comprising means for electronically exporting the document in response to approval of the electronic document export request.

15. The data processing system of claim 9, wherein said export control reviewer is a first export control reviewer, said data processing system further comprising:
means, responsive to said first export control reviewer annotating the electronic document export request as approved for export, for automatically notifying a second export control reviewer of the electronic document export request and for permitting the export control reviewer to electronically access, review and annotate the electronic document export request; and
means for archiving the electronic document export request and for indicating to a user that export of the document has been approved only in response to both of said first and second export control reviewers annotating the electronic document export request with approval of export of the document.

16. The data processing system of claim 9, and further comprising means, responsive to the export control reviewer annotating the electronic document export request with rejection of the electronic document export request, for electronically indicating said rejection to the user and permitting the user to modify the electronic document export request.

17. A program product comprising a computer usable medium having program code embodied therein, said program code including:
means, responsive to one or more user inputs into a data processing system, for building and submitting an electronic document export request specifying a document for which export authorization is requested, an identity of an export control reviewer, and an indication of an export control policy under which export of the document is permitted;
means, responsive to submission of the electronic document export request, for automatically notifying the export control reviewer of the electronic document export request and permitting the export control reviewer to electronically access, review and annotate the electronic document export request; and
means, responsive to the export control reviewer annotating the electronic document export request as approved, for electronically archiving the electronic document export request and electronically indicating to a user that export of the document has been approved.

18. The program product of claim 17, wherein said means for building an electronic document export request comprises means for building an electronic document export request including an electronic copy of the document to be exported.

19. The program product of claim 17, and further comprising means for automatically notifying the user that export of the document has been approved.

20. The program product of claim 17, wherein said means for building an electronic document export request comprises means for building an electronic document export request including a format attribute indicating a medium format of the document.

21. The program product of claim 17, wherein the means for building an electronic document export request comprises means for building an electronic document export request including a written certification by the user that export of the document complies with applicable export regulations.

22. The program product of claim 17, and further comprising means for electronically exporting the document in response to approval of the electronic document export request.

23. The program product of claim 17, wherein said export control reviewer is a first export control reviewer, said data processing system further comprising:
means, responsive to said first export control reviewer annotating the electronic document export request as approved for export, for automatically notifying a second export control reviewer of the electronic document export request and for permitting the export control reviewer to electronically access, review and annotate the electronic document export request; and
means for archiving the electronic document export request and for indicating to a user that export of the document has been approved only in response to both of said first and second export control reviewers annotating the electronic document export request with approval of export of the document.

24. The program product of claim 17, and further comprising means, responsive to the export control reviewer annotating the electronic document export request with rejection of the electronic document export request, for electronically indicating said rejection to the user and permitting the user to modify the electronic document export request.
